(19) United States
(12) Patent Application Publication
(10) Pub. No.: US 2022/0393773 A1
(43) Pub. Date: Dec. 8, 2022

(54) OPTICAL POWER FEEDING SYSTEM

(71) Applicant: KYOCERA CORPORATION, Kyoto-shi, Kyoto (JP)

(72) Inventor: Takehiko SUYAMA, Yamato-shi, Kanagawa (JP)

(21) Appl. No.: 17/754,996

(22) PCT Filed: Sep. 30, 2020
(86) PCT No.: PCT/JP2020/037069

§ 371 Date: Apr. 18, 2022

(30) Foreign Application Priority Data
Oct. 21, 2019 (JP) 2019-191752

(51) Int. Cl. H04B 10/80; H02J 50/30

(52) U.S. Cl. CPC H04B 10/807; H02J 50/30

(57) ABSTRACT

To increase optical power feed efficiency, an optical power feeding system includes power sourcing equipment including a semiconductor laser that lases using electric power and outputs power feed light in a pulsed manner, and a powered device including a photoelectric conversion element that converts the power feed light into electric power. The power sourcing equipment has a clock signal generation unit that generates a clock signal from a pulsed output of the power feed light , and the powered device has a clock signal extraction unit that extracts the clock signal from the power feed light. Accordingly, the amount of electric power to be supplied is controlled more appropriately, it is not necessary to separately transmit a clock signal, and optical power feed efficiency is increased.

### RELATED APPLICATIONS

The present application is a National Phase of International Application No. PCT/JP2020/037069 filed Sep. 30, 2020, which claims priority to Japanese Application No. 2019-191752, filed Oct. 21, 2019.

### TECHNICAL FIELD

The present disclosure relates to an optical power feeding system.

### BACKGROUND ART

Studies have recently been made on an optical power feeding system that converts electric power into light (referred to as power feed light), transmits the power feed light, converts the power feed light into electric energy, and uses the electric energy as electric power.

PTL 1 describes an optical communication device including a light transmitter that transmits signal light modulated by an electric signal and power feed light for feeding electric power; an optical fiber including a core that transmits the signal light, a first clad that is formed around the core, that has a smaller refractive index than the core, and that transmits the power feed light, and a second clad that is formed around the first clad and that has a smaller refractive index than the first clad; and a light receiver that is operated by electric power generated by converting the power feed light transmitted through the first clad of the optical fiber and that converts the signal light transmitted through the core of the optical fiber into the electric signal.

### CITATION LIST

### Patent Literature

PTL 1: Japanese Unexamined Patent Application Publication No. 2010-135989

### SUMMARY OF INVENTION

### Technical Problem

In optical power feed, a further increase in optical power feed efficiency is required. To achieve this, an increase in photoelectric conversion efficiency on a power feed side and a power reception side is required.

In addition, it is necessary to transmit signal light separately from power feed light in the case of transmitting data together with electric power.

### Solution to Problem

An optical power feeding system according to an aspect of the present disclosure includes:

power sourcing equipment including a semiconductor laser that lases using electric power and outputs power feed light in a pulsed manner; and

a powered device including a photoelectric conversion element that converts the power feed light into electric power, in which the power sourcing equipment has a clock signal generation unit that generates a clock signal from a pulsed output of the power feed light, and

the powered device has a clock signal extraction unit that extracts the clock signal from the power feed light.

### BRIEF DESCRIPTION OF DRAWINGS

FIG. 1 is a configuration diagram of a power over fiber (PoF) system according to a first embodiment of the present disclosure.

FIG. 2 is a configuration diagram of a PoF system according to a second embodiment of the present disclosure.

FIG. 3 is a configuration diagram of the PoF system according to the second embodiment of the present disclosure and illustrates optical connectors and so forth.

FIG. 4 is a configuration diagram of a PoF system according to another embodiment of the present disclosure.

FIG. 5 is a configuration diagram of a configuration example (1) of a PoF system added with a configuration in which a power feeding semiconductor laser outputs a pulse.

FIG. 6A is a diagram illustrating changes in the intensity of power feed light output under PWM control and illustrates a case where the amount of power feed is at a middle level.

FIG. 6B is a diagram illustrating changes in the intensity of power feed light output under PWM control and illustrates a case where the amount of power feed is larger.

FIG. 7 is a configuration diagram of a configuration example (2) of a PoF system added with a configuration in which a power feeding semiconductor laser outputs a pulse.

### DESCRIPTION OF EMBODIMENTS

Hereinafter, an embodiment of the present disclosure will be described with reference to the drawings.

### OVERVIEW OF SYSTEM

### First Embodiment

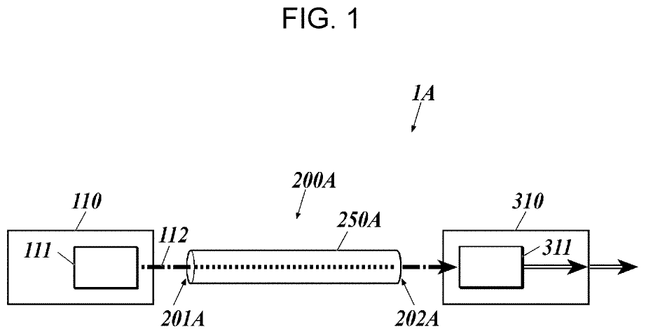

As illustrated in FIG. 1, a power over fiber (PoF) system 1A serving as an optical power feeding system of the present embodiment includes power sourcing equipment (PSE) 110, an optical fiber cable 200A, and a powered device (PD) 310.

In the present disclosure, power sourcing equipment is equipment that converts electric power into optical energy and supplies the optical energy, and a powered device is a device that is supplied with optical energy and converts the optical energy into electric power.

The PSE 110 includes a power feeding semiconductor laser 111.

The optical fiber cable 200A includes an optical fiber 250A serving as a transmission path of power feed light.

The PD 310 includes a photoelectric conversion element 311.

The PSE 110 is connected to a power source, and the power feeding semiconductor laser 111 and so forth are electrically driven.

The power feeding semiconductor laser 111 lases using electric power from the power source, and outputs power feed light 112.

The optical fiber cable 200A has a one end 201A connectable to the PSE 110 and an other end 202A connectable to the PD 310, and transmits the power feed light 112.

The power feed light 112 from the PSE 110 is input to the one end 201A of the optical fiber cable 200A, propagates through the optical fiber 250A, and is output from the other end 202A to the PD 310.

The photoelectric conversion element 311 converts the power feed light 112 transmitted through the optical fiber cable 200A into electric power. The electric power generated through the conversion by the photoelectric conversion element 311 serves as driving power that is necessary within the PD 310. Furthermore, the PD 310 is capable of outputting the electric power generated through the conversion by the photoelectric conversion element 311 to an external device.

A semiconductor material constituting a semiconductor region having a photoelectric conversion effect of the power feeding semiconductor laser 111 and the photoelectric conversion element 311 is a semiconductor having a short laser wavelength of 500 nm or less.

A semiconductor having a short laser wavelength has a large band gap and high photoelectric conversion efficiency. Thus, the photoelectric conversion efficiency on the power generation side and the power reception side of optical power feed increases, and optical power feed efficiency increases.

Thus, as the semiconductor material, for example, a semiconductor material of a laser medium having a laser wavelength (fundamental wave) of 200 to 500 nm, such as diamond, gallium oxide, aluminum nitride, or GaN, may be used.

As the semiconductor material, a semiconductor having a band gap of 2.4 eV or more is applied.

For example, a semiconductor material of a laser medium having a band gap of 2.4 to 6.2 eV, such as diamond, gallium oxide, aluminum nitride, or GaN, may be used.

Laser light tends to have higher transmission efficiency as the wavelength increases, and have higher photoelectric conversion efficiency as the wavelength decreases. Thus, in the case of long-distance transmission, a semiconductor material of a laser medium having a laser wavelength (fundamental wave) of more than 500 nm may be used. In the case of giving priority to photoelectric conversion efficiency, a semiconductor material of a laser medium having a laser wavelength (fundamental wave) of less than 200 nm may be used.

These semiconductor materials may be applied to either one of the power feeding semiconductor laser 111 and the photoelectric conversion element 311. The photoelectric conversion efficiency on the power feed side or the power reception side increases, and the optical power feed efficiency increases.

### Second Embodiment

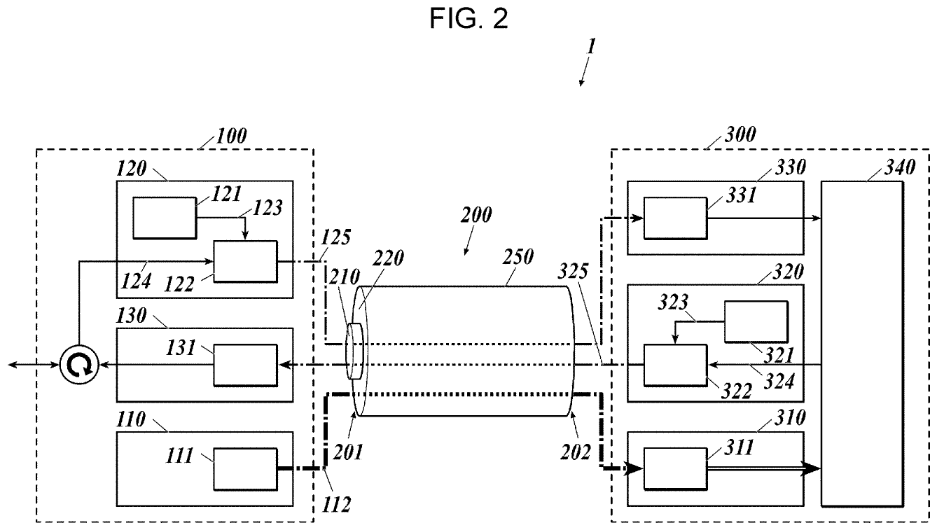

As illustrated in FIG. 2, a PoF system 1 serving as an optical power feeding system of the present embodiment includes an optical power feeding system and an optical communication system that use an optical fiber, and includes a first data communication device 100 including PSE 110, an optical fiber cable 200, and a second data communication device 300 including a PD 310.

In the following description, basically, elements that have already been described are denoted by the same reference numerals and are assumed to have the same configurations as those described above unless otherwise specified.

The PSE 110 includes a power feeding semiconductor laser 111. The first data communication device 100 includes, in addition to the PSE 110, a transmission unit 120 that performs data communication, and a reception unit 130. The first data communication device 100 corresponds to data terminal equipment (DTE), a repeater, or the like. The transmission unit 120 includes a signal semiconductor laser 121 and a modulator 122. The reception unit 130 includes a signal photodiode 131.

The optical fiber cable 200 includes an optical fiber 250 including a core 210 serving as a transmission path of signal light and a clad 220 disposed around the perimeter of the core 210 and serving as a transmission path of power feed light.

The PD 310 includes a photoelectric conversion element 311. The second data communication device 300 includes, in addition to the PD 310, a transmission unit 320, a reception unit 330, and a data processing unit 340. The second data communication device 300 corresponds to a power end station or the like. The transmission unit 320 includes a signal semiconductor laser 321 and a modulator 322. The reception unit 330 includes a signal photodiode 331. The data processing unit 340 is a unit that processes a received signal. The second data communication device 300 is a node in a communication network. Alternatively, the second data communication device 300 may be a node that communicates with another node.

The first data communication device 100 is connected to a power source, and the power feeding semiconductor laser 111, the signal semiconductor laser 121, the modulator 122, the signal photodiode 131, and so forth are electrically driven. The first data communication device 100 is a node in the communication network. Alternatively, the first data communication device 100 may be a node that communicates with another node.

The power feeding semiconductor laser 111 lases using electric power from the power source, and outputs power feed light 112.

The photoelectric conversion element 311 converts the power feed light 112 transmitted through the optical fiber cable 200 into electric power. The electric power generated through the conversion by the photoelectric conversion element 311 serves as driving power of the transmission unit 320, the reception unit 330, and the data processing unit 340, and also driving power that is necessary within the second data communication device 300. Furthermore, the second data communication device 300 may be capable of outputting the electric power generated through the conversion by the photoelectric conversion element 311 to an external device.

On the other hand, the modulator 122 of the transmission unit 120 modulates, based on transmission data 124, laser light 123 from the signal semiconductor laser 121, and outputs the resultant light as signal light 125.

The signal photodiode 331 of the reception unit 330 demodulates the signal light 125 transmitted through the optical fiber cable 200 into an electric signal, and outputs the electric signal to the data processing unit 340. The data processing unit 340 transmits data corresponding to the electric signal to a node, whereas receives data from the node and outputs the data as transmission data 324 to the modulator 322.

The modulator 322 of the transmission unit 320 modulates, based on the transmission data 324, laser light 323 from the signal semiconductor laser 321, and outputs the resultant light as signal light 325.

The signal photodiode 131 of the reception unit 130 demodulates the signal light 325 transmitted through the optical fiber cable 200 into an electric signal, and outputs the electric signal. Data corresponding to the electric signal is transmitted to a node, whereas data from the node is regarded as the transmission data 124.

The power feed light 112 and the signal light 125 from the first data communication device 100 are input to a one end 201 of the optical fiber cable 200, the power feed light 112 propagates through the clad 220, the signal light 125 propagates through the core 210, and the power feed light 112 and the signal light 125 are output from an other end 202 to the second data communication device 300.

The signal light 325 from the second data communication device 300 is input to the other end 202 of the optical fiber cable 200, propagates through the core 210, and is output from the one end 201 to the first data communication device 100.

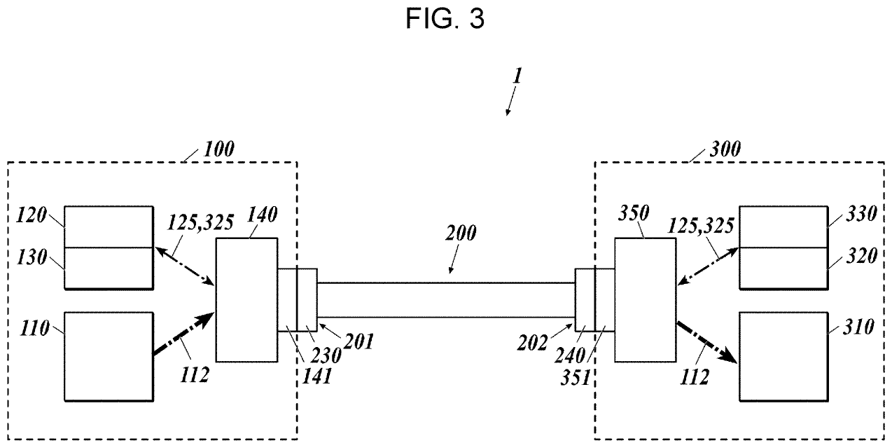

As illustrated in FIG. 3, the first data communication device 100 is provided with a light input/output unit 140 and an optical connector 141 attached thereto. The second data communication device 300 is provided with a light input/output unit 350 and an optical connector 351 attached thereto. An optical connector 230 provided at the one end 201 of the optical fiber cable 200 is connected to the optical connector 141. An optical connector 240 provided at the other end 202 of the optical fiber cable 200 is connected to the optical connector 351. The light input/output unit 140 guides the power feed light 112 to the clad 220, guides the signal light 125 to the core 210, and guides the signal light 325 to the reception unit 130. The light input/output unit 350 guides the power feed light 112 to the PD 310, guides the signal light 125 to the reception unit 330, and guides the signal light 325 to the core 210.

As described above, the optical fiber cable 200 has the one end 201 connectable to the first data communication device 100 and the other end 202 connectable to the second data communication device 300, and transmits the power feed light 112. Furthermore, in the present embodiment, the optical fiber cable 200 bidirectionally transmits the signal light 125 and the signal light 325.

As a semiconductor material constituting a semiconductor region having a photoelectric conversion effect of the power feeding semiconductor laser 111 and the photoelectric conversion element 311, a semiconductor material similar to that of the above-described first embodiment is applied, and high optical power feed efficiency is realized.

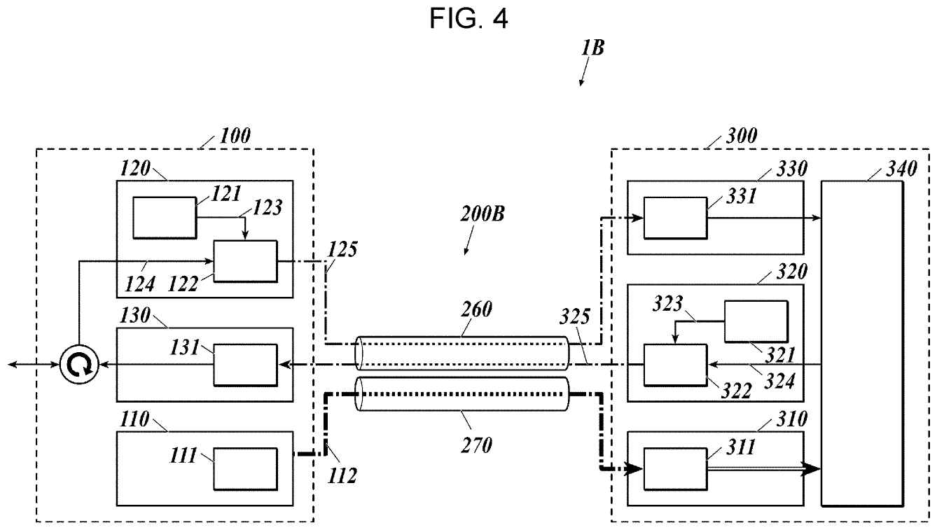

As in an optical fiber cable 200B of a PoF system 1B serving as an optical power feeding system illustrated in FIG. 4, an optical fiber 260 that transmits signal light and an optical fiber 270 that transmits power feed light may be separately provided. The optical fiber cable 200B may be made up of a plurality of cables.

### Configuration in Which Power Feeding Semiconductor Laser Outputs Pulse

### Configuration Example (1) in Which Power Feeding Semiconductor Laser Outputs Pulse

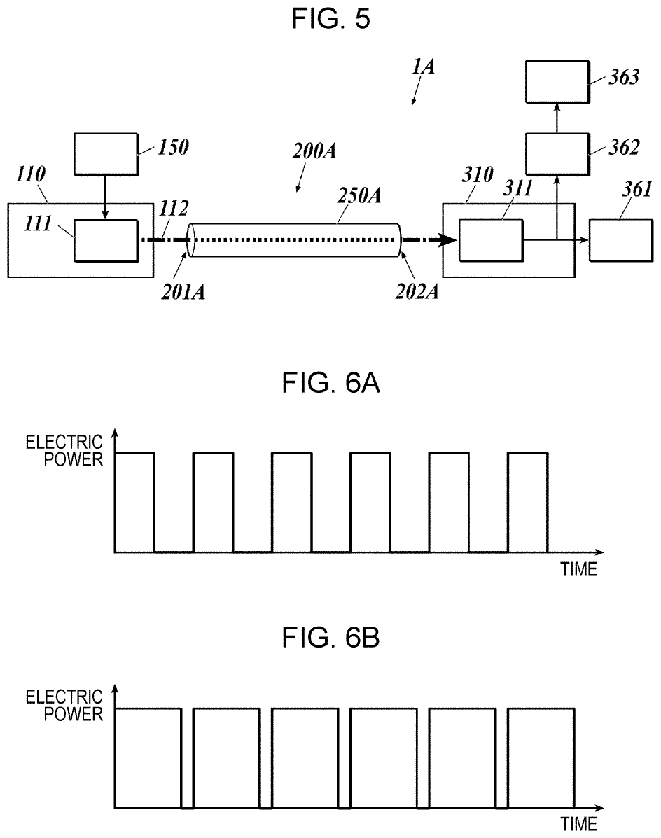

Next, a configuration example (1) in which a power feeding semiconductor laser outputs a pulse will be described with reference to FIG. 5. FIG. 5 is a configuration diagram of the configuration example (1) of the above-described PoF system 1A added with a configuration in which the power feeding semiconductor laser 111 outputs a pulse.

In the following description, basically, elements that have already been described are denoted by the same reference numerals and are assumed to have the same configurations as those described above unless otherwise specified.

In the configuration example (1), to enable the power feeding semiconductor laser 111 of the PSE 110 to output a pulse, for example, there is provided a control device 150 that switches between ON (turn-on state) and OFF (turn-off state) of an excitation source of the power feeding semiconductor laser 111.

The control device 150 alternately repeats ON and OFF in a constant cycle and in a continuous manner, and also performs pulse width modulation (PWM) of increasing or decreasing a ratio (duty ratio) of an ON period to adjust an output. For example, when the electric power required on the PD 310 side is a middle level, the width of the ON period of the pulsed output is set to a middle level, as illustrated in FIG. 6A. When the electric power required on the PD 310 side is larger, the width of the ON period of the pulsed output is set to be larger than in FIG. 6A, as illustrated in FIG. 6B.

The control device 150 performs a process of generating a clock signal from a pulsed output of the power feed light 112. That is, the control device 150 controls the power feeding semiconductor laser 111 to output the power feed light 112 in a pulsed manner while maintaining a predetermined cycle (clock cycle), to achieve clock synchronization between the PSE 110 and the PD 310. The cycle for achieving clock synchronization by the control device 150 can be changed.

Accordingly, the control device 150 functions as a clock signal generation unit that generates a clock signal from a pulsed output of the power feed light 112.

The control device 150 may be constituted by a microcomputer or may be constituted by a sequencer that uses an analog circuit or a digital circuit.

As described above, even in the case of outputting the power feed light 112 in a pulsed manner in a predetermined cycle to achieve clock synchronization, the output of the power feed light 112 can be adjusted as appropriate by adjusting the duty ratio in PWM control. Thus, power can be fed at a target output while a clock signal is transmitted to the PD 310 side.

On the other hand, the photoelectric conversion element 311 of the PD 310 receives the power feed light 112 output in a pulsed manner, and outputs electric power in a pulsed manner.

As illustrated in FIG. 5, the photoelectric conversion element 311 is accompanied with a power smoothing device 361 that smooths electric power output in a pulsed manner. The power smoothing device 361 includes a smoothing circuit, smooths electric power that periodically repeats ON and OFF to convert the electric power into smoothed electric power that periodically repeats a gentle increase and decrease, and inputs the smoothed electric power to a load that is not illustrated, such as an external device serving as a destination to be supplied with the electric power. The power smoothing device 361 may have a configuration including a smoothing circuit capable of outputting substantially constant electric power that does not increase or decrease.

The PD 310 is provided with a clock signal extraction unit 362 that extracts a clock signal from pulsed electric power output by the photoelectric conversion element 311. The clock signal extraction unit 362 generates, from pulsed electric power output by the photoelectric conversion element 311, a clock signal equal to a cycle in which ON and OFF are repeated, and outputs the clock signal.

The clock signal extraction unit 362 outputs the generated clock signal to a control device 363.

Accordingly, the control device 363 for the PD 310 achieves clock synchronization with the control device 150 for the PSE 110. The control device 150 and the control device 363 cooperate with each other in a synchronized manner and execute predetermined control or processing defined individually.

As described above, in the PoF system 1A of the configuration example (1), the semiconductor laser 111 outputs power feed light in a pulsed manner, and thus the amount of electric power to be supplied can be easily controlled with the laser wavelength kept constant. For example, changing of the duty ratio of the pulsed output of power feed light of the semiconductor laser 111 makes it possible to proportionally increase or decrease the amount of electric power to be supplied, and to appropriately control the amount of electric power to be supplied.

In addition, because the amount of electric power to be supplied can be increased or decreased, appropriate measures can be taken to suppress excessive supply of electric power when the amount of electric power to be supplied that is based on the power feed light output from the PSE 110 is excessive.

In the configuration example (1), as a new application of the pulsed output of the power feed light 112 in addition to the application of controlling the amount of electric power to be supplied, a clock signal can be generated by using a pulse of the power feed light 112, and the clock signal can be transmitted from the PSE 110 to the PD 310. Thus, clock synchronization between the devices can be achieved in accordance with optimization of the amount of electric power to be supplied using the pulsed output of the power feed light 112.

Furthermore, a clock signal can be easily transmitted between the PSE 110 and the PD 310, and clock synchronization between the PSE 110 and the PD 310 can be achieved without providing an independent signal transmission path.

Accordingly, as a result of mounting the PSE 110 in one of devices required to achieve highly accurate clock synchronization, for example, clock synchronization between information processing devices or clock synchronization between base stations of wireless communication, and mounting the PD 310 in the other device, favorable clock synchronization can be realized while power feed is performed.

According to the configuration example (1), even if communication means for a clock signal is not provided between devices, a clock signal can be transmitted through the optical fiber cable 200A for feeding power, and thereby clock synchronization can be realized. For example, the configuration example (1) is effective to the application of, for example, the case of controlling a blink cycle of lighting to perform appropriate image capturing between the frame rate of an in-vehicle camera and an in-vehicle lighting device or the like such as an LED.

Furthermore, according to the configuration example (1), even if communication means for a clock signal is provided between devices, clock synchronization can be achieved between the PSE 110 side and the PD 310 side before startup of the system is completed.

The applications described herein are merely examples, and the configuration example (1) can be applied to any application that requires clock synchronization to be achieved between the PSE 110 and the PD 310.

The power smoothing device 361 for smoothing electric power generated through conversion by the PD 310 is provided on the PD 310 side, and thus stable power supply can be performed with less fluctuation.

### Configuration Example (2) in Which Power Feeding Semiconductor Laser Outputs Pulse

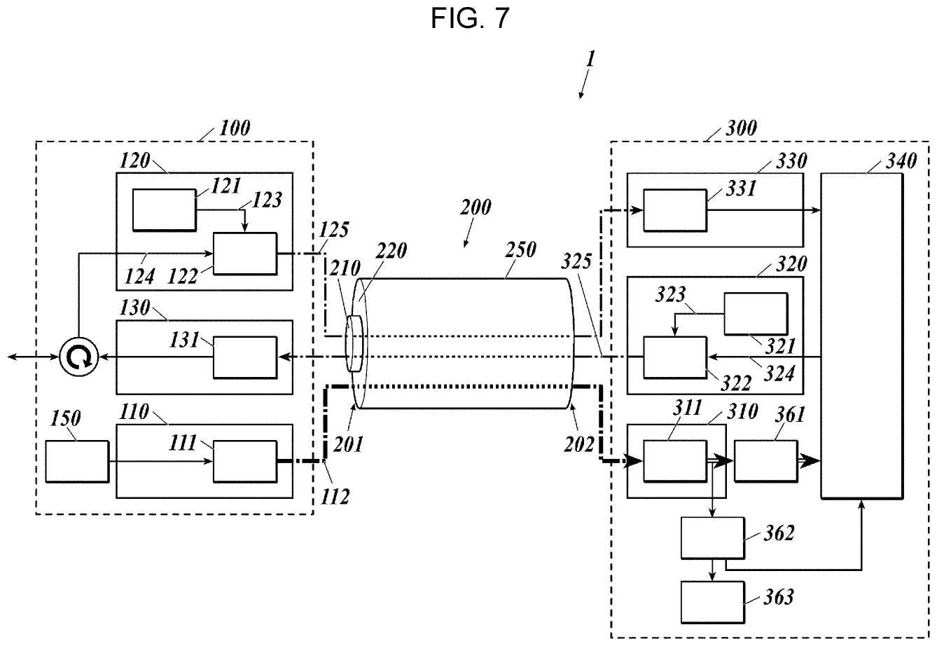

Next, a configuration example (2) in which a power feeding semiconductor laser outputs a pulse will be described with reference to FIG. 7. FIG. 7 is a configuration diagram of the configuration example (2) of the above-described PoF system 1 added with a configuration in which the power feeding semiconductor laser 111 outputs a pulse.

In the configuration example (2), the first data communication device 100 including the PSE 110 includes the control device 150 that is the same as that in the configuration example (1), the power feed light 112 is output in a pulsed manner in a specified cycle, and a process of generating a clock signal from the pulsed output of the power feed light 112 is performed.

The second data communication device 300 includes the power smoothing device 361, the clock signal extraction unit 362, and the control device 363 that are the same as those in the configuration example (1).

The power smoothing device 361 supplies smoothed electric power to the individual components of the second data communication device 300.

The clock signal extraction unit 362 outputs a generated clock signal to the control device 363 or the data processing unit 340 including a computation device.

The PoF system 1 of the configuration example (2) has the same advantages as those of the PoF system 1A of the configuration example (1).

In the PoF system 1 of the configuration example (2), communication using the signal light 125 and the signal light 325 can be performed between the first data communication device 100 and the second data communication device 300, and thus a clock signal can be transmitted by using the signal light 125.

However, in the configuration example (2), a clock signal is transmitted by using the power feed light 112, and thereby it is possible to suppress data communication jam in the signal light 125 and increase the amount of communication.

In addition, clock synchronization can be quickly achieved from the start of transmission and reception of the power feed light 112 before the first data communication device 100 and the second data communication device 300 complete startup of the system.

The PoF system 1 of the configuration example 2 can also be applied to any application that requires clock synchronization between devices.

### Others

While the embodiments of the present disclosure have been described above, the embodiments have been given as examples, and other various embodiments can be made. The elements may be omitted, replaced, or changed without deviating from the gist of the invention.

For example, the configuration example 2 illustrates an example of applying a configuration in which the power feeding semiconductor laser outputs a pulse to the PoF system 1. A configuration in which the power feeding semiconductor laser outputs a pulse or a configuration in which a clock signal is transmitted and received can be applied to the PoF system 1B.

### INDUSTRIAL APPLICABILITY

An optical power feeding system according to the present invention has industrial applicability in an optical power feeding system that performs power feed by changing a laser wavelength.

1. An optical power feeding system comprising:
power sourcing equipment including a semiconductor laser that lases using electric power and outputs power feed light in a pulsed manner; and
a powered device including a photoelectric conversion element configured to convert the power feed light into electric power, wherein the power sourcing equipment has a clock signal generation unit configured to generate a clock signal from a pulsed output of the power feed light, and the powered device has a clock signal extraction unit configured to extract the clock signal from the power feed light.

2. The optical power feeding system according to claim 1, wherein the power sourcing equipment is provided with a control device configured to adjust an amount of power feed from the semiconductor laser in accordance with a pulse width of the power feed light.

3. The optical power feeding system according to claim 1, wherein the powered device is provided with a smoothing circuit configured to smooth the electric power generated through conversion.

4. The optical power feeding system according to claim 1, wherein a semiconductor material constituting a semiconductor region having a photoelectric conversion effect of the semiconductor laser is a laser medium having a laser wavelength of 500 nm or less.

5. The optical power feeding system according to claim 1, wherein a semiconductor material constituting a semiconductor region having a photoelectric conversion effect of the photoelectric conversion element is a laser medium having a laser wavelength of 500 nm or less.
